(19) United States
(12) Patent Application Publication
(10) Pub. No.: US 2016/0197350 A1
(43) Pub. Date: Jul. 7, 2016

(54) FLAT NONAQUEOUS ELECTROLYTE SECONDARY BATTERY AND BATTERY PACK INCLUDING THE SAME

(71) Applicant: SANYO ELECTRIC CO., LTD., Daito-shi, Osaka (JP)

(72) Inventors: Daisuke Nishide, Hyogo (JP); Daizo Jito, Hyogo (JP); Takeshi Ogasawara, Hyogo (JP); Hiroyuki Fujimoto, Osaka (JP)

(73) Assignee: SANYO Electric Co., Ltd., Daito-shi, Osaka (JP)

(21) Appl. No.: 14/910,745

(22) PCT Filed: Sep. 26, 2014
(86) PCT No.: PCT/JP2014/004931

§ 371 Date: Feb. 8, 2016

(30) Foreign Application Priority Data
Sep. 30, 2013 (JP) 2013-203346

(51) Int. Cl. H01M 4/62; H01M 4/505; H01M 10/04; H01M 10/0525; H01M 10/0585; H01M 4/131; H01M 4/525

(52) U.S. Cl. CPC H01M 4/624; H01M 4/131; H01M 4/505; H01M 4/525; H01M 10/0525; H01M 10/0585; H01M 10/0468; H01M 2004/028

(57) ABSTRACT

A flat nonaqueous electrolyte secondary battery that sustains good charge/discharge cycles even if the capacity of a positive electrode is increased. A flat nonaqueous electrolyte secondary battery according to an aspect of the present invention includes a positive electrode plate having a positive electrode mix layer containing a positive electrode active material, a negative electrode plate having a negative electrode mix layer containing a negative electrode active material, an electrode assembly having a structure in which the positive electrode plate and the negative electrode plate are stacked with a separator therebetween, and a nonaqueous electrolyte solution. A compound containing at least one of elements M belonging to group 5 in the periodic table is present in the positive electrode mix layer. The flat nonaqueous electrolyte secondary battery has pressure applied from outside in a direction in which the positive electrode, the negative electrode, and the separator are stacked.

### TECHNICAL FIELD

The present invention relates to a flat nonaqueous electrolyte secondary battery and a battery pack including the same.

### BACKGROUND ART

In recent years, smaller and lighter mobile data terminals such as mobile phones, notebook personal computers, and smartphones have been increasingly used and secondary batteries used as driving power supplies therefor have been required to have higher capacity. Nonaqueous electrolyte secondary batteries, which are charged and discharged in such a manner that lithium ions move between positive and negative electrodes during charge and discharge, have high energy density and high capacity and therefore are widely used as driving power supplies for the above mobile data terminals.

Furthermore, the nonaqueous electrolyte secondary batteries are recently attracting attention as utility power supplies for electric tools, electric vehicles (EVs), hybrid electric vehicles (HEVs and PHEVs), and the like and applications thereof are expected to be further expanded. Such utility power supplies need to have high capacity so as to be used for a long time or enhanced output characteristics in the case of repeating large-current charge and discharge in a relatively short time. In particular, in applications such as electric tools, EVs, HEVs, and PHEVs, it is essential that output characteristics during large-current charge/discharge are maintained and high capacity is achieved.

In order to increase the capacity of a nonaqueous electrolyte secondary battery, while it is conceivable that an active material with high capacity is used in a positive electrode, attempts to improve capacity retention and power retention after cycles are necessary.

For example, Patent Literature 1 suggests that power retention after cycles is increased by the use of a positive electrode active material that is prepared in such a manner that Zr and a Ta oxide are added to a lithium transition metal oxide containing Li element and a transition metal element which is at least one selected from the group consisting of Ni, Co, and Mn (where the molar amount of Li element is 1.2 times greater than the total molar amount of the transition metal element), followed by firing at low temperature.

Patent Literature 2 shows that the reduction in power of a battery including an insulating particle layer placed on a surface of a negative electrode can be suppressed in such a manner that an insulating particle layer including an alumina sub-layer is provided on a surface of a negative electrode in an automotive battery and the construction pressure of the battery is adjusted to 4 kgf/cm² (0.39 MPa) to 50 kgf/cm² (4.91 MPa).

### CITATION LIST

### Patent Literature

PTL 1: Japanese Published Unexamined Patent Application No. 2012-138197

PTL 2: Japanese Published Unexamined Patent Application No. 2010-113966

### SUMMARY OF INVENTION

### Technical Problem

However, it has become apparent that a battery with low positive electrode resistance after cycles cannot be obtained even if techniques disclosed in Patent Literatures 1 and 2 are used.

### Solution to Problem

According to an aspect of the present invention, a flat nonaqueous electrolyte secondary battery includes a positive electrode plate having a positive electrode mix layer containing a positive electrode active material capable of reversibly storing and releasing lithium, a negative electrode plate having a negative electrode mix layer containing a negative electrode active material capable of reversibly storing and releasing lithium, an electrode assembly having a structure in which the positive electrode plate and the negative electrode plate are stacked with a separator therebetween, and a nonaqueous electrolyte solution. A compound containing at least one selected from the group consisting of elements M belonging to group 5 in the periodic table is present in the positive electrode mix layer. The flat nonaqueous electrolyte secondary battery has pressure applied from outside in a direction in which the positive electrode, the negative electrode, and the separator are stacked.

Furthermore, according to an aspect of the present invention, a battery pack in which a plurality of flat nonaqueous electrolyte secondary batteries are connected to each other in series, parallel, or series-parallel includes a positive electrode plate having a positive electrode mix layer containing a positive electrode active material capable of reversibly storing and releasing lithium, a negative electrode plate having a negative electrode mix layer containing a negative electrode active material capable of reversibly storing and releasing lithium, an electrode assembly having a structure in which the positive electrode plate and the negative electrode plate are stacked with a separator therebetween, and a nonaqueous electrolyte solution. A compound containing at least one selected from the group consisting of elements M belonging to group 5 in the periodic table is present in the positive electrode mix layer. The flat nonaqueous electrolyte secondary batteries, which make up the battery pack, are arranged in a direction in which the positive electrode plate, the negative electrode plate, and the separator are stacked. The flat nonaqueous electrolyte secondary batteries are constrained to each other in the arrangement direction. The flat nonaqueous electrolyte secondary batteries have confining pressure applied from outside in the direction in which the positive electrode, the negative electrode, and the separator are stacked.

### Advantageous Effects of Invention

In accordance with a flat nonaqueous electrolyte secondary battery according to an aspect of the present invention and a battery pack according to another aspect of the present invention, a battery with low positive electrode resistance after cycles can be obtained even if a high-capacity active material is used in a positive electrode.

### BRIEF DESCRIPTION OF DRAWINGS

FIG. 1 is a perspective view of a flat electrode assembly.

FIG. 2A is a front schematic view of a laminate-type nonaqueous electrolyte secondary battery and FIG. 2B is sectional view taken along the line IIB-IIB of FIG. 2A.

FIG. 3A is a schematic view of an uncharged secondary particle portion of a positive electrode active material used in Experiment Example 4 and FIG. 3B is a schematic view of the charged secondary particle portion.

FIG. 4 is a graph showing a Nyquist plot.

### DESCRIPTION OF EMBODIMENTS

A flat nonaqueous electrolyte secondary battery according to an aspect of the present invention and a battery pack are described below in detail using various experiment examples. The experiment examples below are exemplified in order to illustrate an example of the flat nonaqueous electrolyte secondary battery and an example of the battery pack for the purpose of embodying the technical spirit of the present invention. It is not intended to limit the present invention to any of these experiment examples. The present invention is equally applicable to various modifications of those illustrated in these experiment examples without departing from the technical spirit described in the claims.

### First Experiment Example

### Experiment Example 1

The configuration of a flat nonaqueous electrolyte secondary battery of Experiment Example 1 is described.

[Preparation of Positive Electrode Plate]

Lithium carbonate Li₂CO₃ and a nickel-cobalt-manganese composite hydroxide, represented by [Ni_{0.35}Co_{0.35}Mn_{0.30}](OH)₂, obtained by coprecipitation were mixed together in an Ishikawa-type Raikai mortar such that the molar ratio of Li to all transition metals was 1.10:1. The mixture was heat-treated at 1,000° C. for 20 hours in an air atmosphere, followed by crushing, whereby a lithium-nickel-cobalt-manganese composite oxide, represented by Li_{1.06}[Ni_{0.33}Co_{0.33}Mn_{0.28}]O₂, having an average secondary particle size of about 15 μm was obtained.

Next, the lithium-nickel-cobalt-manganese composite oxide represented by Li_{1.06}[Ni_{0.33}Co_{0.33}Mn_{0.28}]O₂ and Ta₂O₅ with an average particle size of 0.2 μm were mixed together at a predetermined ratio, whereby a positive electrode active material containing the lithium-nickel-cobalt-manganese composite oxide and Ta₂O₅ partly attached to the surface thereof was prepared. The content of Ta₂O₅ in the positive electrode active material, which was prepared as described above, was 0.3 mole percent.

Carbon black serving as a positive electrode conductive agent, polyvinylidene fluoride (PVdF) serving as a binder, and an adequate amount of N-methyl-2-pyrrolidone were added to the positive electrode active material, which was obtained as described above, such that the mass ratio of the positive electrode active material to the positive electrode conductive agent to the binder was 92:5:3, followed by kneading, whereby positive electrode mix slurry was prepared. Thereafter, the positive electrode mix slurry was evenly applied to both surfaces of a positive electrode current collector made from aluminium foil and was then dried, followed by rolling with a rolling roller, whereby the packing density of positive electrode mix layers formed on both surfaces of the positive electrode current collector was adjusted to 2.6 g/cm³. Furthermore, a positive electrode current-collecting tab was attached to a surface of the positive electrode current collector, whereby a positive electrode plate including the positive electrode current collector and the positive electrode mix layers formed on both surfaces thereof was prepared.

[Preparation of Negative Electrode Plate]

Synthetic graphite serving as a negative electrode active material and SBR (styrene-butadiene rubber) serving as a binder were added to an aqueous solution prepared by dissolving CMC (carboxymethylcellulose sodium) which was a thickening agent in water such that the mass ratio of the negative electrode active material to the binder to the thickening agent was 98:1:1, followed by kneading, whereby negative electrode mix slurry was prepared. The negative electrode mix slurry was evenly applied to both surfaces of a negative electrode current collector made from copper foil and was dried, followed by rolling with a rolling roller. A negative electrode current-collecting tab was attached to a surface of the negative electrode current collector, whereby a negative electrode plate including the positive electrode current collector and negative electrode mix layers formed on both surfaces thereof was prepared.

[Preparation of Nonaqueous Electrolyte Solution]

Lithium hexafluorophosphate (LiPF₆) was dissolved in a solvent mixture prepared by mixing ethylene carbonate (EC), methyl ethyl carbonate (MEC), and dimethyl carbonate (DMC) at a volume ratio of 3:3:4 at 25° C. such that the concentration of lithium hexafluorophosphate was 1.2 moles per liter. Furthermore, 1% by mass of vinylene carbonate (VC) was added to and dissolved in an electrolyte solution, whereby a nonaqueous electrolyte solution was prepared.

[Preparation of Battery]

The single positive electrode plate, the single negative electrode plate, and two separators each including a microporous membrane made of polyethylene were used to prepare a flat roll. First, the positive electrode plate 16 and the negative electrode plate 17 were placed opposite to each other in such a state that the positive electrode plate 16 and the negative electrode plate 17 were insulated from each other with the separators 18 (refer to FIG. 2B). After the positive electrode plate 16, the negative electrode plate 17, and the separators 18 were spirally wound around a winding core with a cylindrical shape such that a positive electrode tab 11 and a negative electrode tab 12 were outermost, the winding core was pulled out, whereby a wound electrode assembly was prepared. The wound electrode assembly was squashed, whereby the flat roll 13 was obtained. The flat roll 13 had a structure in which the positive electrode plate 16 and the negative electrode plate 17 were stacked with the separators 18 therebetween.

The flat roll 13, which was prepared as described above, and the above nonaqueous electrolyte solution were provided in an enclosure 14 made of an aluminium laminate in a glove box under an argon atmosphere, whereby a laminate-type nonaqueous electrolyte secondary battery 10 having a structure shown in FIGS. 2A and 2B, a thickness d of 3.6 mm, a width of 3.5 cm, and a length of 6.2 cm was prepared. The laminate-type nonaqueous electrolyte secondary battery 10 included the positive electrode plate 16; the positive electrode tab 11; the negative electrode plate 17; the negative electrode tab 12; the enclosure 14, which was made of the aluminium laminate material; and a closed portion 15 formed by heat-sealing end portions of the aluminium laminate material. The nonaqueous electrolyte solution and the flat roll 13 were sealed in the enclosure 14, which was made of the aluminium laminate material.

Next, the laminate-type nonaqueous electrolyte secondary battery 10 was set such that a pressure (construction pressure) of 0.0883 MPa (0.9 kgf/cm²) was applied to the flat roll 13 in thickness d directions shown in FIG. 2B, that is, in directions (the directions of arrows in FIG. 2B) in which the positive electrode plate 16, the negative electrode plate 17, and the separators 18 were stacked, whereby the flat nonaqueous electrolyte secondary battery of Experiment Example 1 was obtained.

### Experiment Example 2

A flat nonaqueous electrolyte secondary battery of Experiment Example 2 was prepared in substantially the same manner as that used in Experiment Example 1 except that a lithium-nickel-cobalt-manganese composite oxide, represented by Li_{1.06}[Ni_{0.33}Co_{0.33}Mn_{0.28}]O₂, mixed with no Ta₂O₅ was used as a positive electrode active material.

### Experiment Example 3

A flat nonaqueous electrolyte secondary battery of Experiment Example 3 was prepared in substantially the same manner as that used in Experiment Example 1 except that no construction pressure was applied.

### Experiment Example 4

A flat nonaqueous electrolyte secondary battery of Experiment Example 4 was prepared in substantially the same manner as that used in Experiment Example 1 except that a lithium-nickel-cobalt-manganese composite oxide, represented by Li_{1.06}[Ni_{0.33}Co_{0.33}Mn_{0.28}]O₂, mixed with no Ta₂O₅ was used as a positive electrode active material and no construction pressure was applied.

[Measurement of Positive Electrode Resistance]

The flat nonaqueous electrolyte secondary batteries of Experiment Examples 1 to 4 that were prepared as described above were repeatedly charged and discharged under conditions below. The flat nonaqueous electrolyte secondary batteries of Experiment Examples 1 to 4 were measured for positive electrode resistance after 40 cycles.

Charge Conditions in First Cycle

Constant-current charge was performed at a constant current of 700 mA until the voltage of each battery reached 4.4 V (the positive electrode potential was 4.5 V on a lithium basis). After the battery voltage reached 4.4 V, constant-voltage charge was performed at a constant voltage of 4.4 V until the current reached 35 mA.

Discharge Conditions in First Cycle

Constant-current discharge was performed at a constant-current of 700 mA until the battery voltage reached 3.0 V.

Rest

The rest interval between the above charge and discharge was 10 minute.

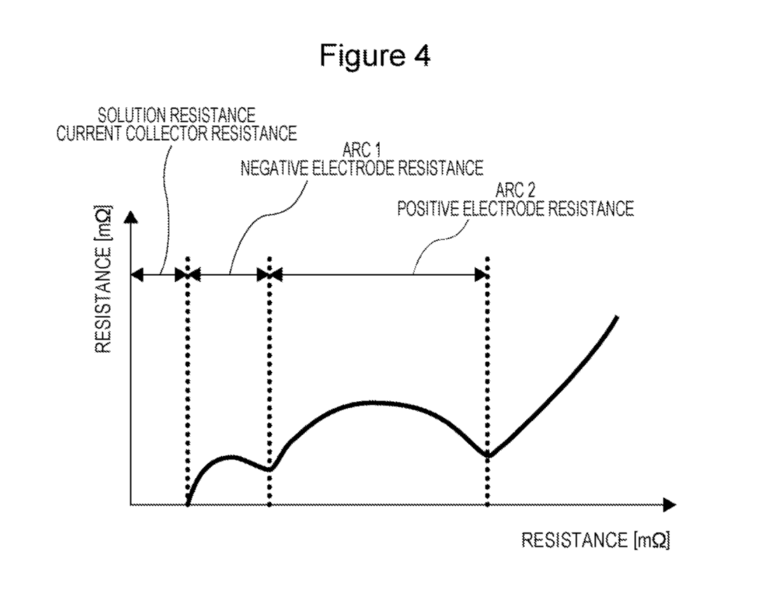

Charge and discharge performed under the above conditions were defined as one cycle. The charge/discharge cycle was performed 40 times. After 40 cycles, each battery was charged under charge conditions in the first cycle until the voltage of the battery reached 4.4 V. The charged battery was measured for resistance by an alternating-current impedance method. A method for measuring the resistance is described below. A Nyquist plot shown in FIG. 4 is obtained using a frequency response analyzer and a potentiogalvanostat (manufactured by Solartron). The Nyquist plot shows the sum of current collector resistance, solution resistance, negative electrode resistance, and positive electrode resistance. In FIG. 4, the positive electrode resistance is represented by Arc 2.

The batteries of Experiment Examples 1 to 4 were measured for positive electrode resistance after 40 cycles by the above measurement method. The relative value of the positive electrode resistance of each of the batteries of Experiment Examples 1 to 3 was determined on the basis that the positive electrode resistance of the battery of Experiment Example 4 was 100. The relative value thereof was defined as the positive electrode resistance ratio after 40 cycles. Results were shown in Table 1.

TABLE 1

| | | Construction | Positive electrode |
|---|---|---|---|
| | | pressure | resistance ratio after |
| | Added compound | (MPa) | 40 cycles |
| Experiment | Ta₂O₅ | 8.83 × 10⁻² | 60 |
| Example 1 | | | |
| Experiment | Not | 8.83 × 10⁻² | 73 |
| Example 2 | added | | |
| Experiment | Ta₂O₅ | 0 | 106 |
| Example 3 | | | |
| Experiment | Not | 0 | 100 |
| Example 4 | added | | |

As is clear from the results shown in Table 1, the battery of Experiment Example 1 that includes the positive electrode mix layers containing Ta₂O₅ and that is under a construction pressure of 8.83×10⁻² MPa (0.9 kgf/cm²) has lower positive electrode resistance after cycles as compared to the batteries of Experiment Examples 2 to 4. The battery of Experiment Example 2 that includes the positive electrode mix layers containing no Ta₂O₅ and that is under the construction pressure has lower positive electrode resistance after cycles as compared to the battery of Experiment Example 4 that includes the positive electrode mix layers containing no Ta₂O₅ and that is under no construction pressure and exhibits a certain improvement. The battery of Experiment Example 3 that includes the positive electrode mix layers containing Ta₂O₅ and that is under no construction pressure has higher positive electrode resistance after cycles as compared to the battery of Experiment Example 4 that includes the positive electrode mix layers containing no Ta₂O₅ and that is under no construction pressure. However, the battery of Experiment Example 1 that includes the positive electrode mix layers containing Ta₂O₅ and that is under the construction pressure exhibits an improvement far beyond an effect due to the construction pressure only.

The reason why these results are obtained is probably as described below. That is, in the battery of Experiment Example 4 that is under no construction pressure and that includes the positive electrode mix layers containing no added compound, the decomposition reaction of the nonaqueous electrolyte solution occurs on the surfaces of secondary particles 21 of the positive electrode active material as shown in FIG. 3 and therefore deterioration proceeds from interfaces between primary particles located near the surfaces of the secondary particles to cause cracks 24 at junction interfaces between the primary particles. Furthermore, cracks 23 are caused in the secondary particles 21 by the expansion and contraction of the positive electrode active material in charge/discharge cycles to divide the secondary particles 21 into primary particles 22, resulting in an increase in positive electrode resistance after cycles.

In the battery of Experiment Example 3 that is under no construction pressure and that includes the positive electrode mix layers containing an added compound, the decomposition reaction of the nonaqueous electrolyte solution on the surfaces of secondary particles can be suppressed by the added compound present near the surfaces of particles of the negative electrode active material. However, the cracks 23 are caused in the secondary particles by the expansion and contraction of the positive electrode active material in charge/discharge cycles because of no construction pressure; the formation of primary particles cannot be prevented; and the added compound, which is insulating, acts as a resistor, resulting in an increase in positive electrode resistance after cycles.

In the battery of Experiment Example 2 that is under the construction pressure and that includes the positive electrode mix layers containing no added compound, the formation of cracks in secondary particles by the expansion and contraction of the positive electrode active material can be suppressed by the application of the construction pressure. However, the decomposition reaction of the nonaqueous electrolyte solution occurs on the surfaces of secondary particles because of no added compound and therefore the deterioration of the surfaces of the secondary particles occurs. In particular, the deterioration starts from junction interfaces between primary particles located near the surfaces of the secondary particles of the positive electrode active material to cause the cracks 24 at the interfaces therebetween, resulting in an increase in positive electrode resistance after cycles.

In contrast, in the battery of Experiment Example 1 that is under the construction pressure and that includes the positive electrode mix layers containing the added compound, both of the decomposition reaction of the nonaqueous electrolyte solution on the surfaces of secondary particles and the cracking of the positive electrode active material (in secondary particles and at junction interfaces between primary particles) can be suppressed. Therefore, the positive electrode resistance after cycles is probably much lower than the resistance due to the presence of the added compound, which is insulating.

### Second Experiment Example

### Experiment Example 5

A flat nonaqueous electrolyte secondary battery of Experiment Example 5 was prepared in substantially the same manner as that used in Experiment Example 1 except that the construction pressure applied to the battery was 0.13 MPa instead of 0.0883 MPa (0.9 kgf/cm²).

### Experiment Example 6

A flat nonaqueous electrolyte secondary battery of Experiment Example 6 was prepared in substantially the same manner as that used in Experiment Example 1 except that the construction pressure applied to the battery was 0.22 MPa instead of 0.0883 MPa (0.9 kgf/cm²).

As with the case of the batteries of Experiment Examples 1 to 4, the batteries of Experiment Examples 5 and 6 that were prepared as described above were subjected to charge/discharge cycle testing, followed by calculating the positive electrode resistance ratio after 40 cycles. Results were summarized in Table 2 together with the results of Experiment Examples 1 and 3.

TABLE 2

| | | Construction | Positive electrode |
|---|---|---|---|
| | | pressure | resistance ratio after |
| | Added compound | (MPa) | 40 cycles |
| Experiment | Ta₂O₅ | 0 | 106 |
| Example 3 | | | |
| Experiment | Ta₂O₅ | 0.0883 | 60 |
| Example 1 | | | |
| Experiment | Ta₂O₅ | 0.1300 | 63 |
| Example 5 | | | |
| Experiment | Ta₂O₅ | 0.2200 | 60 |
| Example 6 | | | |

As is clear from the results shown in Table 2, the batteries of Experiment Examples 5 and 6 that include the positive electrode mix layers containing Ta₂O₅ and that are under a construction pressure of higher than 0.0883 MPa (0.9 kgf/cm²) have more excellent cycle characteristics as compared to the battery of Experiment Example 3 that is under no construction pressure. The batteries of Experiment Examples 5 and 6, as well as the battery of Experiment Example 1 that is under a construction pressure of 0.0883 MPa, exhibit a small positive electrode resistance ratio. From this, it is conceivable that the case where the construction pressure is 0.13 MPa or 0.22 MPa exhibits an effect similar to that in the case where the construction pressure is 0.0883 MPa. Furthermore, while the construction pressure applied to the battery of Experiment Example 6 is two times or more the construction pressure applied to the battery of Experiment Example 1, the batteries of Experiment Examples 1 and 6 exhibit the same positive electrode resistance ratio. This is probably because the effect of suppressing cracks in secondary particles by the construction pressure is saturated at about 0.0883 MPa. Thus, in the case where the construction pressure is higher than 0.22 MPa, an effect similar to that in Experiment Examples 5 and 6 can be expected.

In Experiment Example 1, 5, or 6, the case where the construction pressure is 0.0883 MPa, 0.13 MPa, or 0.22 MPa, respectively, is described. When the construction pressure is 9.81×10⁻³ MPa (0.1 kgf/cm²) or more, a similar effect is obtained. When the construction pressure is less than 9.81×10⁻³ MPa, cracks are likely to be caused in secondary particles of the positive electrode active material and cycle characteristics are reduced. The upper limit of the construction pressure is not particularly limited from the viewpoint of suppressing cracks in the secondary particles of the positive electrode active material and is preferably 10 MPa or less in consideration of the pressure resistance of a battery case.

In Experiment Examples 1, 5, and 6, the case where the added compound used is a compound containing Ta is described. The added compound used may be a compound containing at least one selected from the group consisting of elements M belonging to group 5 in the periodic table. A combination of such a flat nonaqueous electrolyte secondary battery, the added compound, and the construction pressure suppresses the deterioration of the positive electrode active material due to the reaction of the nonaqueous electrolyte solution on the surface of the positive electrode active material or at interfaces between particles of the positive electrode active material, leading to increases in cycle characteristics.

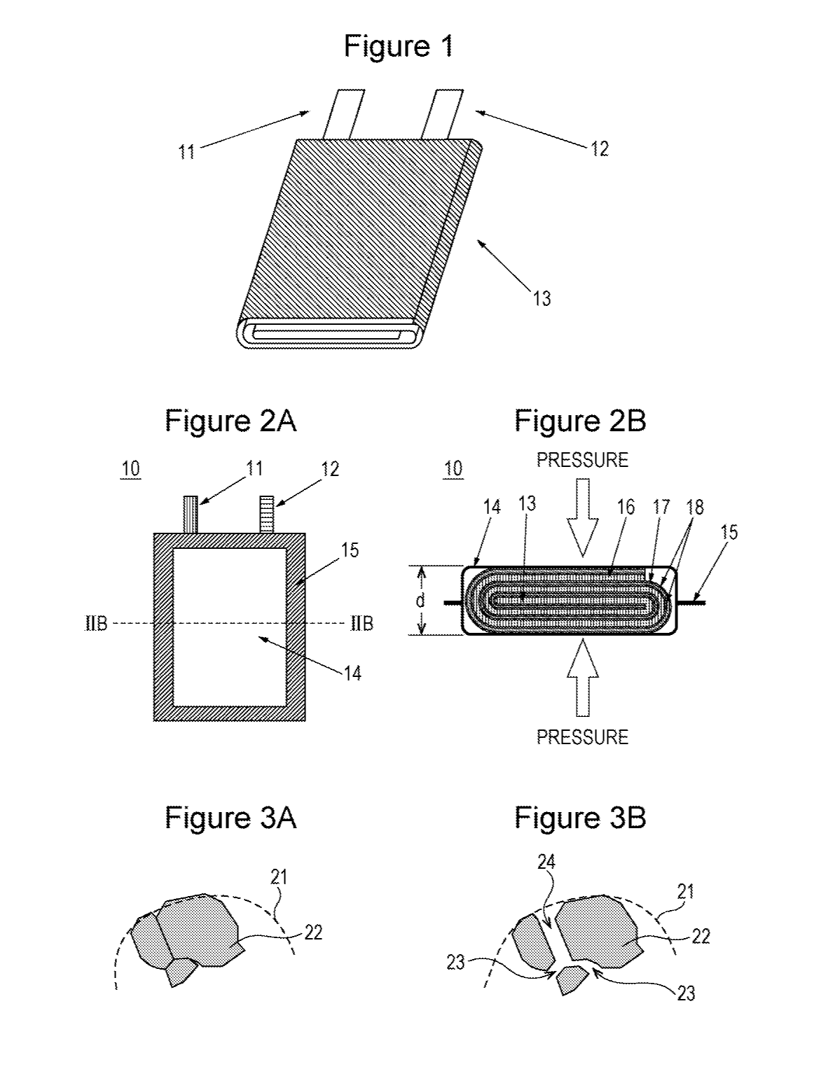

In each of Experiment Examples 1, 5, and 6, the use of the following roll is described: the flat roll 13 (refer to FIGS. 1 and 2B), which was prepared in such a manner that the positive electrode plate 16 and the negative electrode plate 17 were placed opposite to each other in such a state that the positive electrode plate 16 and the negative electrode plate 17 were insulated from each other with the separators 18 (refer to FIG. 2B), followed by spirally winding the positive electrode plate 16, the negative electrode plate 17, and the separators 18 and then squashing. However, in an aspect of the present invention, a similar action effect is obtained by the use of a stacked electrode assembly (not shown) prepared in such a manner that a positive electrode plate and a negative electrode plate are stacked in such a state that the positive electrode plate and the negative electrode plate are insulated from each other with a separator.

Furthermore, in each of Experiment Examples 1, 5, and 6, the use of the enclosure 14, made of the aluminium laminate material, housing the flat roll 13 is described. An enclosure used in the present invention is not particularly limited and may be one for use in conventional cells, that is, one that transmits the pressure applied to a flat nonaqueous electrolyte secondary battery from outside to a flat roll placed therein. Examples of such an enclosure include metal cans and aluminium laminates. In the present invention, even when the enclosure is made of different materials or has different thicknesses, a target pressure can be applied to the flat roll by appropriately adjusting the pressure applied to the flat nonaqueous electrolyte secondary battery from outside. In a battery pack, a target pressure can be applied to each of flat rolls by appropriately adjusting confining pressure. In each of Experiment Examples 1, 5, and 6, the aluminium laminate material is used to make up the enclosure 14 and a configuration in which the inner surface of the enclosure 14 is in tight contact with the flat roll 13. According to this configuration, a pressure substantially equivalent to the pressure applied to the flat nonaqueous electrolyte secondary battery from outside is probably transmitted to the flat roll 13 in the enclosure 14. In the case where a rectangular metal can is used as an enclosure, when the inner surface of the enclosure is in tight contact with a flat roll as with the case of Experiment Examples 1, 5, and 6, a pressure substantially equivalent to the pressure applied to a flat nonaqueous electrolyte secondary battery from outside is probably transmitted to a flat roll placed in the enclosure.

Furthermore, in each of Experiment Examples 1, 5, and 6, the case where the added compound present in the positive electrode mix is the oxide is described. The added compound is preferably at least one selected from the group consisting of hydroxides, oxides, oxyhydroxides, carbonates, phosphates, and fluorine-containing compounds. The use of these compounds provides a similar effect.

According to an aspect of the present invention, a positive electrode active material preferably contains secondary particles formed by the aggregation of the positive electrode active material containing a plurality of primary particles. This is because a nonaqueous electrolyte solution permeates inside and therefore output performance is higher as compared to when the positive electrode active material is made of primary particles only.

According to an aspect of the present invention, a positive electrode active material preferably has an average grain size of 450 Å or more as determined by the Halder-wagner approach from the integral width determined by the Pawley method.

### Reference Experiment Examples

### Reference Experiment Example 1

First, the configuration of a three-electrode test cell used in Reference Experiment Example 1 is described.

[Preparation of Positive Electrode Plate]

Lithium carbonate Li₂CO₃ and a nickel-cobalt-manganese composite hydroxide, represented by [Ni_{0.55}Co_{0.10}Mn_{0.35}](OH)₂, obtained by coprecipitation were mixed together in an Ishikawa-type Raikai mortar such that the molar ratio of Li to all transition metals was 1.10:1. Next, the mixture was heat-treated at 960° C. for 20 hours in an air atmosphere, followed by crushing, whereby a lithium-nickel-cobalt-manganese composite oxide, represented by Li_{1.07}[Ni_{0.51}Co_{0.10}Mn_{0.32}]O₂, having an average secondary particle size of about 15 μm was obtained.

A positive electrode plate was prepared in the same manner as that used in Experiment Example 1 except that the positive electrode active material obtained as described above was used.

The three-electrode test cell was prepared in such a manner that the positive electrode plate was used as a working electrode and metallic lithium was used as a counter electrode and a reference electrode. As a nonaqueous electrolyte, lithium hexafluorophosphate (LiPF₆) was dissolved in a solvent mixture prepared by mixing ethylene carbonate (EC), methyl ethyl carbonate (MEC), and dimethyl carbonate (DMC) at a volume ratio of 3:3:4 such that the concentration of lithium hexafluorophosphate was 1.0 mole per liter. Furthermore, the following solution was used: a nonaqueous electrolyte solution that was prepared in such a manner that 1% by mass of vinylene carbonate (VC) was added to and dissolved in an electrolyte solution. The three-electrode test cell prepared as described above is hereinafter referred to as the battery of Reference Experiment Example 1.

### Reference Experiment Example 2

A three-electrode test cell was prepared in substantially the same manner as that used in Reference Experiment Example 1 except that the heat treatment temperature was set to 930° C. when a positive electrode active material was prepared. The three-electrode test cell prepared as described above is hereinafter referred to as the battery of Reference Experiment Example 2.

### Reference Experiment Example 3

A three-electrode test cell was prepared in substantially the same manner as that used in Reference Experiment Example 1 except that the heat treatment temperature was set to 900° C. when a positive electrode active material was prepared. The three-electrode test cell prepared as described above is hereinafter referred to as the battery of Reference Experiment Example 3.

### Reference Experiment Example 4

A three-electrode test cell was prepared in substantially the same manner as that used in Reference Experiment Example 1 except that the heat treatment temperature was set to 870° C. when a positive electrode active material was prepared. The three-electrode test cell prepared as described above is hereinafter referred to as the battery of Reference Experiment Example 4.

[Evaluation of Initial Discharge Capacity and Cracks in Secondary Particles of Positive Electrode Active Material]

The batteries of Reference Experiment Examples 1 to 4 that were prepared as described above were charged and discharged under conditions below, followed by evaluating initial discharge capacity and whether cracks were present in secondary particles of the positive electrode active material after 50 cycles.

Charge Conditions in First Cycle

Constant-current charge was performed at a current density of 0.2 mA/cm² until the positive electrode potential reached 4.3 V (vs. Li/Li⁺). After the positive electrode potential reached 4.3 V (vs. Li/Li⁺), constant-voltage charge was performed at a constant voltage of 4.3 V until the current density reached 0.04 mA/cm².

Discharge Conditions in First Cycle

Constant-current discharge was performed at a current density of 0.2 mA/cm² until the voltage of each battery reached 2.5 V (vs. Li/Li⁺). In this operation, the discharge capacity was measured and was defined as the initial discharge capacity.

Rest

The rest interval between the above charge and discharge was 10 minutes.

Charge Conditions in Second and Subsequent Cycles

Constant-current charge was performed at a current density of 2.0 mA/cm² until the positive electrode potential reached 4.3 V (vs. Li/Li⁺). After the positive electrode potential reached 4.3 V (vs. Li/Li⁺), constant-voltage charge was performed at a constant voltage of 4.3 V until the current density reached 0.04 mA/cm².

Discharge Conditions in Second and Subsequent Cycles

Constant-current discharge was performed at a current density of 2.0 mA/cm² until the battery voltage reached 2.5 V (vs. Li/Li⁺).

Rest

The rest interval between the above charge and discharge was 10 minutes.

Charge and discharge performed under the above conditions in the first cycle were defined as one cycle and the charge/discharge cycle was performed once. Thereafter, charge and discharge performed under the above conditions in the second and subsequent cycles were defined as one cycle and this charge/discharge cycle was repeatedly performed 49 times. After 50 cycles, each battery was disassembled and the positive electrode plate was taken out. The positive electrode plate taken out was used to prepare a cross section of each secondary particle with a cross-section polisher or the like and the cross section was observed with a SEM and a TEM, whereby whether cracks were present in the secondary particle was checked.

[Evaluation of Average Grain Size of Positive Electrode Active Material]

Aside from the above, the positive electrode active materials obtained in Reference Experiment Examples 1 to 4 were used. The average grain size of each positive electrode active material was evaluated by the Halder-wagner method from the integral width determined by the Pawley method. The average grain size of the positive electrode active material was determined by a procedure below.

<How to Determine Average Grain Size L>

(1) Ten peaks with the Miller indices (100), (110), (111), (200), (210), (211), (220), (221), (310), and (311) are used from the X-ray diffraction pattern of an X-ray diffraction reference material (National Institute of Standards and Technology (NIST) Standard Reference Materials (SRM) 660b(LaB6)) and the integral width β1 is calculated from the integrated intensity and the peak height by the Pawley method using a split pseudo-voigt function.

(2) Ten peaks with the Miller indices (003), (101), (006), (012), (104), (015), (107), (018), (110), and (113) are used from the X-ray diffraction pattern of a measurement sample (lithium-transition metal composite oxide), fitting is performed by the Pawley method using a split pseudo-voigt function, and the integral width β2 is calculated from the integrated intensity and the peak height.

(3) The integral width β obtained from the measurement sample is calculated from the above results by Equation (a) below.

Integral width β obtained from measurement sample=β2−β1 (a)

(4) The average grain size L of the measurement sample is calculated by the Halder-wagner approach from the slope of a straight line approximated by plotting β2/tan 2δ against β/(tan θ sin θ).

An X-ray diffraction pattern was measured in such a manner that the lithium-transition metal composite oxide was filled in a sample holder and was measured with an X-ray diffractometer (RINT-TTR2 manufactured by Rigaku Corporation) using Cu-Kα radiation under conditions including a tube voltage of 50 kV and a tube current of 300 mA.

Ten peaks, used to calculate the average grain size, in the X-ray diffraction pattern of the lithium-transition metal composite oxide are as described below.
A peak, located at 2θ=18.7°, indexed to the Miller indices (003).
A peak, located at 2θ=36.7°, indexed to the Miller indices (101).
A peak, located at 2θ=37.9°, indexed to the Miller indices (006).
A peak, located at 2θ=38.4°, indexed to the Miller indices (012).
A peak, located at 2θ=44.5°, indexed to the Miller indices (104).
A peak, located at 2θ=48.6°, indexed to the Miller indices (015).
A peak, located at 2θ=58.6°, indexed to the Miller indices (107).
A peak, located at 2θ=64.4°, indexed to the Miller indices (018).
A peak, located at 2θ=65.0°, indexed to the Miller indices (110).
A peak, located at 2θ=68.3°, indexed to the Miller indices (113).

The average grain size of each positive electrode active material, the initial discharge capacity, and cracks in secondary particles after cycles are summarized in Table 3.

TABLE 3

| | | Initial | |
|---|---|---|---|
| | Average | discharge | Cracks in secondary |
| | grain size | capacity | particles after 50 |
| | (\acute{Å}) | (mAh/g) | cycles |
| Reference | 2,470 | 165 | Present |
| Experiment | | | |
| Example 1 | | | |
| Reference | 1,080 | 164 | Present |
| Experiment | | | |
| Example 2 | | | |
| Reference | 470 | 162 | Present |
| Experiment | | | |
| Example 3 | | | |
| Reference | 360 | 152 | Not present |
| Experiment | | | |
| Example 4 | | | |

As is clear from Table 3, the average grain size positive electrode active material is preferably 470 Å or more as determined by the Halder-wagner approach from the integral width determined by the Pawley method in order to allow the positive electrode active material to have high capacity. However, it is suggested when the average grain size thereof is large, cracks are likely to be caused in secondary particles by the expansion and contraction of the positive electrode active material during charge and discharge and the positive electrode resistance is likely to be large because of contact failures due to cracks in the positive electrode active material. In the present invention, a compound containing at least one selected from the group consisting of elements M belonging to group 5 in the periodic table is present in a positive electrode mix and a pressure is applied to a flat nonaqueous electrolyte secondary battery in a direction in which a positive electrode, a negative electrode, and a separator are stacked. Therefore, even though the above high-capacity positive electrode active material is used, the positive electrode resistance after cycles can be maintained low.

In Reference Experiment Examples 1 to 4, whether cracks were present in secondary particles after cycles was checked under the above conditions. As the temperature is higher or charge is performed at higher voltage, particles are more likely to crack. Therefore, when the average grain size is 360 Å, particles are unlikely to crack in a wide temperature range and a wide voltage range, though the particles never crack under any conditions. However, when the average grain size is 360 Å, a reduction in capacity is large. Therefore, the average grain size is preferably 450 Å or more.

According to an aspect of the present invention, a compound present in a positive electrode mix is preferably partly attached to the surfaces of secondary particles of the active material. This is because when excessively covering the surfaces of the secondary particles with the compound causes reductions in rate characteristics, a reduction in discharge capacity, and the like. In the case where a compound containing at least one selected from the group consisting of elements M belonging to group 5 in the periodic table is mixed with particles of a positive electrode active material, followed by heat treatment at a temperature of, for example, 450° C. or lower, the compound can be tightly attached to the particles. This reduces the deterioration of the surfaces of secondary particles and interfaces between primary particles.

According to an aspect of the present invention, a compound present in a positive electrode mix is preferably a compound containing at least one selected from the group consisting of elements M belonging to group 5 in the periodic table. This is because a compound of an element M belonging to group 5 can efficiently suppress the decomposition reaction of an electrolyte solution by the catalysis of a transition metal such as Co or Ni. In particular, tantalum, which is highly stable in electrolyte solutions, is preferable.

The total mass of the above elements is preferably about 0.01% to 5% by mass of the total mass of particles of the positive electrode active material and the compound containing the above elements and more preferably 0.02% to 1% by mass. When the total mass of the above elements is less than 0.01% by mass, the effect of improving characteristics is low. When the total mass of the above elements is greater than 5% by mass, discharge rate characteristics are low.

Cracks due to deterioration may possibly be initiated from not only junction interfaces between the primary particles located near the surfaces of the secondary particles but also junction interfaces between grains depending on the type of the positive electrode active material. Even in this case, cracks initiated from the junction interfaces between the grains can be similarly suppressed by the use of a configuration of the present invention.

According to an aspect of the present invention, the packing density of a positive electrode mix layer is preferably 2.2 g/cm³ to 3.4 g/cm³. This is because when the packing density of the positive electrode mix layer is less than 2.2 g/cm³, the packing density thereof is excessively low and the resistance may possibly increase. When the packing density is more than 3.4 g/cm³, secondary particles aggregated from primary particles are crushed into the primary particles and the positive electrode active material out of contact with a conductive agent is likely to be isolated; hence, the output may possibly be reduced.

Another aspect of the present invention provides a battery pack including a plurality of flat nonaqueous electrolyte secondary batteries which contain the above attached compound and which are connected to each other in series, parallel, or series-parallel. The flat nonaqueous electrolyte secondary batteries, which make up the battery pack, are arranged in a direction in which a positive electrode plate, a negative electrode plate, and a separator are stacked. The flat nonaqueous electrolyte secondary batteries are constrained to each other in the arrangement direction. The flat nonaqueous electrolyte secondary batteries have confining pressure applied from outside in the direction in which the positive electrode, the negative electrode, and the separator are stacked. In this case, the construction pressure is preferably 9.81×10⁻³ MPa or more and more preferably 9.81×10⁻³ MPa to 10 MPa.

The positive electrode active material used may be, for example, a lithium-transition metal composite oxide. In particular, Ni—Co—Mn-based lithium composite oxides and Ni—Co—Al-based lithium composite oxides have high capacity and high input-output characteristics and therefore are preferable. The following oxides are exemplified as other examples: lithium-cobalt composite oxides, Ni—Mn—Al-based lithium composite oxides, and olivine-type transition metal oxides (represented by LiMPO₄, where M is selected from Fe, Mn, Co, and Ni) containing iron, manganese, or the like. These may be used alone or in combination. Furthermore, a substance such as Al, Mg, Ti, Zr, or W may be present in the lithium transition metal composite oxide in the form of a solid solution.

The Ni—Co—Mn-based lithium composite oxides used may be those having a Ni-to-Co-to-Mn molar ratio of 1:1:1, 5:2:3, or 4:4:2 or a known composition. In particular, in order to allow the capacity of a positive electrode to be increased, one having a Ni or Co proportion greater than the proportion of Mn is preferably used and the difference in mole fraction between Ni and Mn is preferably 0.04% or more with respect to the sum of moles of Ni, Co, and Mn. In the case of using the same type or different types of positive electrode active materials, the positive electrode active materials may have the same particle size or different particle sizes.

A nonaqueous electrolyte solution used in a nonaqueous electrolyte secondary battery according to the present invention may be a cyclic carbonate, such as ethylene carbonate, propylene carbonate, butylene carbonate, or vinylene carbonate, conventionally used or a linear carbonate, such as dimethyl carbonate, methyl ethyl carbonate, or diethyl carbonate, conventionally used. In particular, a solvent mixture of the cyclic carbonate and the linear carbonate is a nonaqueous electrolyte solution having low viscosity, a low melting point, and high lithium ion conductivity and is preferably used. The volume ratio of the cyclic carbonate to the linear carbonate is preferably limited to the range of 2:8 to 5:5. The following compounds can be used together with the above solvent: compounds including esters such as methyl acetate, ethyl acetate, propyl acetate, methyl propionate, ethyl propionate, and γ-butyrolactone; compounds, such as propanesultone, containing a sulfo group; compounds including ethers such as 1,2-dimethoxyethane, 1,2-diethoxyethane, tetrahydrofuran, 1,3-dioxane, 1,4-dioxane, and 2-methyltetrahydrofuran; compounds including nitriles such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; compounds including amides such as dimethylformamide; and the like. Furthermore, a solvent in which one or more of these hydrogen atoms H are substituted by fluorine atoms F can be used.

A lithium salt used in a battery containing a positive electrode active material for nonaqueous electrolyte secondary batteries according to the present invention may be, for example, a fluorine-containing lithium salt, such as LiPF₆, LiBF₄, LiCF₃SO₃, LiN(FSO₂)₂, LiN(CF₃SO₂)₂, LiN(C₂F₅SO₂)₂, LiN(CF₃SO₂)(C₄F₉SO₂), LiC(C₂F₅SO₂)₃, or LiAsF₆. Furthermore, one prepared by adding a lithium salt (a lithium salt (for example, LiClO₄ or the like) containing one or more of P, B, O, S, N, and Cl) other than the fluorine-containing lithium salt to the fluorine-containing lithium salt may be used. In particular, the fluorine-containing lithium salt and a lithium salt containing an oxalato complex anion are preferably contained from the viewpoint of forming a stable coating on the surface of a negative electrode in a high-temperature environment.

Examples of the lithium salt containing the oxalato complex anion include LiBOB (lithium bis(oxalate)borate) Li[B(C₂O₄)F₂], Li[P(C₂O₄)F₄], and Li[P(C₂O₄)₂F₂]. In particular, LiBOB, which forms a stable coating on a negative electrode, is preferably used.

A separator used in the nonaqueous electrolyte secondary battery according to the present invention may be a conventionally used separator such as a separator made of polypropylene or polyethylene, a polyethylene-polypropylene multilayer separator, or a separator having a surface coated with resin such as an aramide-based resin.

The separator used may be one conventionally used. In particular, the following separators may be used: a separator made of polyethylene, one including a polyethylene layer and a polypropylene layer formed on a surface thereof, and a polyethylene separator having a surface coated with resin such as an aramide-based resin.

A negative electrode active material used in a negative electrode according to the present invention may be one conventionally used. In particular, a carbon material capable of storing and releasing lithium, a metal that can be alloyed with lithium, or an alloy compound containing the metal is cited. The carbon material may be graphite including natural graphite, non-graphitizable carbon, and synthetic graphite; coke; or the like. The alloy compound may be one containing at least one metal that can be alloyed with lithium. In particular, an element that can be alloyed with lithium is preferably silicon or tin and an alloy of silicon or tin can be used. The surface of the carbon material or the alloy compound may be spotted or covered with another carbon material (amorphous carbon, low-crystallinity carbon, or the like). A mixture of the carbon material and the alloy of silicon or tin can be used. In addition, one that has reduced energy density and higher charge/discharge potential with respect to metallic lithium of lithium titanate or the like as compared to the carbon material or the like can be used as a negative electrode material.

A silicon oxide (SiOₓ (0<x<2, particularly preferably 0<x<1)) may be used as the negative electrode active material in addition to the silicon and the silicon alloy. Thus, the silicon includes silicon in the silicon oxide represented by SiOₓ (0<x<2) (SiOₓ=(Si)_{1-1/2x}+(SiO₂)_{1/2x}). As the negative electrode active material, the carbon material is preferably mainly used and in particular, graphite is preferably mainly used. This allows output regeneration characteristics to be maintained in a wide range of depth of charge/discharge in a combination with the lithium-transition metal composite oxide, which is used as the positive electrode active material in the present invention.

A negative electrode mix layer containing the negative electrode active material may contain a known carbon conductive agent such as graphite, a known binder such as CMC (carboxymethylcellulose sodium) or SBR (styrene-butadiene rubber), or the like.

A layer made of inorganic filler conventionally used can be formed at the interface between the positive electrode and the separator or the interface between the negative electrode and the separator. An oxide, conventionally used, containing one or more of titanium, aluminium, silicon, magnesium, and the like; a phosphate, conventionally used, containing one or more of titanium, aluminium, silicon, magnesium, and the like; or one surface-treated with a hydroxide or the like can be used as filler. The following methods can be used to form the filler layer: a method in which filler-containing slurry is directly applied to the positive electrode, the negative electrode, or the separator; a method in which a sheet formed from filler is attached to the positive electrode, the negative electrode, or the separator; and the like.

A flat nonaqueous electrolyte secondary battery according to an aspect of the present invention can be expected to provide, for example, high output in a wide temperature range, particularly at low temperature, over a long period of time because the resistance of a positive electrode does not increase after cycles. In particular, in multiple series-parallel batteries, high output can be expected to be obtained in a wide temperature range, particularly at low temperature, over a long period of time.

### INDUSTRIAL APPLICABILITY

A flat nonaqueous electrolyte secondary battery according to an aspect of the present invention can be used for applications where, for example, particularly high energy density is necessary for driving power supplies for mobile data terminals such as mobile phones, notebook personal computers, smartphones, and tablet terminals. Furthermore, the flat nonaqueous electrolyte secondary battery can be expected to be developed into high-power applications such as electric vehicles (EVs), hybrid electric vehicles (HEVs and PHEVs), and electric tools.

### REFERENCE SIGNS LIST

10 Laminate-type nonaqueous electrolyte secondary battery
11 Positive electrode tab
12 Negative electrode tab
13 Flat roll
14 Enclosure
15 Closed portion
16 Positive electrode plate
17 Negative electrode plate
18 Separators
21 Secondary particles
22 Primary particles
23 Cracks
24 Cracks

1. A flat nonaqueous electrolyte secondary battery comprising a positive electrode plate having a positive electrode mix layer containing a positive electrode active material capable of reversibly storing and releasing lithium, a negative electrode plate having a negative electrode mix layer containing a negative electrode active material capable of reversibly storing and releasing lithium, an electrode assembly having a structure in which the positive electrode plate and the negative electrode plate are stacked with a separator therebetween, and a nonaqueous electrolyte solution,
wherein a compound containing at least one selected from the group consisting of elements M belonging to group 5 in the periodic table is present in the positive electrode mix layer and the battery has pressure applied from outside in a direction in which the positive electrode, the negative electrode, and the separator are stacked.

2. The flat nonaqueous electrolyte secondary battery according to claim 1, wherein the positive electrode active material contains secondary particles formed by the aggregation of the positive electrode active material containing a plurality of primary particles.

3. The flat nonaqueous electrolyte secondary battery according to claim 1, wherein the positive electrode active material has an average grain size of 450 Å or more as determined by the Halder Wagner approach from the integral width determined by the Pawley method.

4. The flat nonaqueous electrolyte secondary battery according to claim 1, wherein the packing density of the positive electrode mix layer is 2.2 g/cm³ to 3.4 g/cm³.

5. The flat nonaqueous electrolyte secondary battery according to claim 1, wherein the pressure is 9.81×10⁻³ MPa or more.

6. The flat nonaqueous electrolyte secondary battery according to claim 1, wherein the compound present in the positive electrode mix layer is partly attached to the surfaces of the secondary particles in the positive electrode active material.

7. The flat nonaqueous electrolyte secondary battery according to claim 1, wherein the compound present in the positive electrode mix layer contains Ta.

8. The flat nonaqueous electrolyte secondary battery according to claim 1, wherein the compound present in the positive electrode mix layer is at least one selected from the group consisting of hydroxides, oxides, oxyhydroxides, carbonates, phosphates, and fluorine-containing compounds.

9. A battery pack in which a plurality of flat nonaqueous electrolyte secondary batteries are connected to each other in series, parallel, or series-parallel, comprising a positive electrode plate having a positive electrode mix layer containing a positive electrode active material capable of reversibly storing and releasing lithium, a negative electrode plate having a negative electrode mix layer containing a negative electrode active material capable of reversibly storing and releasing lithium, an electrode assembly having a structure in which the positive electrode plate and the negative electrode plate are stacked with a separator therebetween, and a nonaqueous electrolyte solution,
wherein a compound containing at least one selected from the group consisting of elements M belonging to group 5 in the periodic table is present in the positive electrode mix layer; the flat nonaqueous electrolyte secondary batteries, which make up the battery pack, are arranged in a direction in which the positive electrode plate, the negative electrode plate, and the separator are stacked; the flat nonaqueous electrolyte secondary batteries are constrained to each other in the arrangement direction; and the flat nonaqueous electrolyte secondary batteries have confining pressure applied from outside in the direction in which the positive electrode, the negative electrode, and the separator are stacked.

10. The battery pack according to claim 9, wherein the confining pressure is 9.81×10⁻³ MPa or more.
